(19) United States
(12) Patent Application Publication
(10) Pub. No.: US 2006/0056643 A1
(43) Pub. Date: Mar. 16, 2006

(54) Car audio system with unified network structure

(75) Inventor: Su-Hong Ryu, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/165,212

(22) Filed: Jun. 24, 2005

(30) Foreign Application Priority Data
Sep. 15, 2004 (KR) 2004-73956

(51) Int. Cl. H04B 1/00

(52) U.S. Cl. 381/86

(57) ABSTRACT

A car audio system for reproducing audio data from audio sources mounted in a car, amplifying the reproduced audio data through an amplifier, and outputting the amplified audio data as audible sound through a speaker, wherein the audio sources have different output pattern IDs, and are connected to the amplifier via a unified network that transmits the audio data and the output pattern IDs to the amplifier.

### RELATED APPLICATIONS

The present disclosure relates to subject matter contained in Korean Application No. 10 2004-73956, filed on Sep. 15, 2004, which is herein expressly incorporated by reference in its entirety.

### BACKGROUND OF THE INVENTION

1. Field of the Invention

The present invention relates to an audio system, and more particularly to a car audio system with a unified network structure, wherein an amplifier and audio sources in the car are connected to each other by means of a unified network and the output of the amplifier is controlled based on an output pattern D of each audio source.

2. Description of the Related Art

In general, a car audio system mounted in a car plays back radio broadcasts received therein or plays back audio signals recorded in an audio record medium such as a cassette tape or an audio disk.

The car audio system, which is mainly provided to relieve a driver from bordome or satisfy the driver or passengers tastecomprises a head unit including a CD player, a cassette deck, and a radio, an active crossover for filtering signals outputted from the head unit 10 for each frequency band, and an amplifier for outputting the filtered signals.

In general, for typical car audio systems, the above-mentioned components, that is, the head unit, the active crossover and the amplifier, are mounted beside the driver's seat However, for specialized and more expensive car audio systems, only the head unit is mounted beside the driver's seat, and the active crossover and the amplifier are loaded in the trunk.

In the car audio system as configured above, audio source such as the CD player, the cassette deck, the radio, or a navigator, are connected, via respective connection lines, to the amplifier for outputting audio data delivered thereto from the audio sources.

Accordingly, the car audio system has a very complicated structure due to the respective connection lines connected to the audio sources.

FIG. 1 is a block diagram illustrating the configuration of a conventional car audio system. As shown in FIG. 1, the conventional car audio system has a complicated structure where the audio sources, such as a radio 10, a CD player 20, a navigator 30, and a cassette player 40 are connected to an amplifier 60. Therefore, there is a need to simplify such a complicated structure.

In addition, once the output specification of the amplifier 60 is fixed, it is impossible to change the output of the amplifier 60 without modification of hardware or software within the amplifier 60. Accordingly, when a new audio source is installed in the car audio system, there is a problem in that a new car audio system including the new audio source must be installed.

### SUMMARY OF THE INVENTION

Therefore, the present invention has been made in view of the above problem, and it is an object of the present invention to provide a car audio system with a unified network structure, wherein an amplifier and audio sources in a car are connected to each other by means of a unified network and an output of the amplifier is controlled based on an output pattern ID of each audio source.

It is another object of the present invention to provide a car audio system, which is capable of simplifying the entire structure of the car audio system by reducing the number of connection lines between each audio source and an amplifier by connecting each audio source to the amplifier by means of a unified network, and providing a user with convenience and ease of use of the system by causing the amplifier to output audio signals in correspondence to each audio source, thus elimination the need of changing hardware or software of the amplifier.

In accordance with an aspect of the present invention, the above and other objects can be accomplished by the provision of a car audio system for reproducing audio data from audio sources mounted in a car, amplifying the reproduced audio data through an amplifier, and outputting the amplified audio data as audible sound through a speaker, wherein the audio sources have different output pattern IDs, and are connected to the amplifier via a unified network for transmitting the audio data and the output pattern IDs to the amplifier, the amplifier includes an output pattern ID storing unit in which the output pattern IDs set in the audio sources are stored, and, when the audio data and the output pattern IDs are transmitted from the audio sources to the amplifier, one of the output pattern IDS transmitted from the audio sources is compared with one of the output pattern IDs stored in the output pattern ID storing unit and, if the compared output pattern IDs are equal the amplifier outputs an audio signal according to the output specification of an audio source corresponding to the corresponding output pattern ID.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the configuration of a conventional car audio system; and

FIG. 2 is a block diagram illustrating the configuration of a car audio system with a unified network structure in accordance with the present invention.

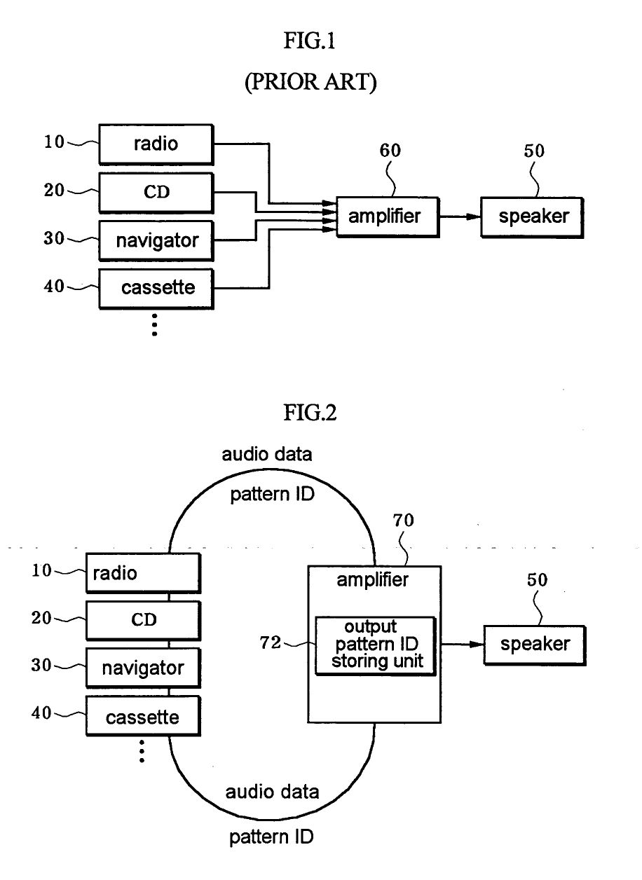

### DESCRIPTION OF THE PREFERRED EMBODIMENTS

Hereinafter, a preferred embodiment of the present invention will be described in detail with reference to the accompanying drawings.

FIG. 2 is a block diagram illustrating the configuration of a car audio system with a unified network structure in accordance with the present invention.

As shown in the figure, a car audio system with a unified network structure in accordance with the present invention comprises audio sources 10, 20, 30 and 40, an amplifier 70, and a speaker.

The audio sources 10, 20, 30 and 40 output respective audio data, and include a radio 10, a CD player 20, a navigator 30, and a cassette player 40, for example. When a user plays back a certain audio source in order to listen to music or any information, the played back audio source transmits audio data to the amplifier.

Here, the car audio system of the present invention may further include audio sources other than the above-mentioned audio sources 10, 20, 30 and 40, if necessary.

On the other hand, the audio sources 10, 20, 30 and 40 have a respective output pattern identification (ID), which contain unique information of audio sources 10, 20, 30 and 40. The amplifier 70 can confirm which of the audio source 10, 20, 30 and 30 are played back

Accordingly, when the audio sources 10, 20, 30 and 40 are played back, they transmit their respective output pattern IDs as well as their audio data to the amplifier 70.

The amplifier 70 includes an output pattern ID storing unit 72 in which the output pattern IDs are stored, and outputs the audio data transmitted from the audio sources 10, 20, 30 and 40 corresponding to the stored output pattern IDs.

In this way, since the output patter IDs transmitted from the audio sources 10, 20, 30 and 40 are stored in the output pattern ID storing unit 72 included in the amplifier 70, the amplifier compares one of the output pattern IDs transmitted from the audio sources 10, 20, 30 and 40 to one of the output patterns IDs stored in the output pattern ID storing unit 72, and, if the compared output pattern IDs are equal, outputs an audio signal according to an output specifications of an audio source 10, 20, 30 and 40 corresponding to the corresponding output pattern ID.

Accordingly, even when output specifications of the audio sources 10, 20, 30 and 40 are changed, the amplifier 70 can output audio data from the audio sources 10, 20, 30 and 40 if only the output pattern IDs are modified and transmitted to the amplifier 70. Accordingly, there is no need to change the specification of the amplifier 70.

After the amplifier 70 outputs the audio data in this way, the user can listen to music or any information through the speaker 50.

As described above, in the car audio system of the present invention, the audio sources 10, 20, 30 and 40 are connected to the amplifier through the unified network, and the amplifier 70 recognizes the output pattern IDs set for the audio sources 10, 20, 30 and 40 and outputs the audio data of the audio sources 10, 20, 30 and 40 according to their output specifications.

Accordingly, since the amplifier 70 can properly output the audio data of the audio sources 10, 20, 30 and 40 through a simple connection structure between the audio sources 10, 20, 30 and 40 and the amplifier 70, the car audio system can be constructed with economical efficiency.

As apparent from the above description, the present invention provides a car audio system with a unified network structure, wherein an amplifier and audio sources in a car are connected to each other by means of a unified network and the output of the amplifier is controlled based on the output pattern ID of each audio source. In addition, the present invention relates to a car audio system, which is capable of simplifying the structure of the car audio system by educing the number of connection lines between each audio source and an amplifier by connecting each audio source to the amplifier by means of a unified network, and providing a user with convenience and ease of use of the system by causing the amplifier to output audio signals in correspondence to each audio source, thus eliminating the need for changing hardware or software of the amplifier.

Furthermore, even when a new audio source is installed in the car audio system, since the amplifier can output audio data from the audio source if only the output pattern ID is modified and transmitted to the amplifier, the amplifier can be efficiently utilized, and moreover, the car audio system can be constructed with economical efficiency.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A car audio system for reproducing audio data from audio sources mounted in a car, amplifying the reproduced audio data through an amplifier, and outputting the amplified audio data as audible sound through a speaker,
wherein the audio sources have different output pattern IDs, and are connected to the amplifier via a unified network that transmits the audio data and the output pattern IDs to the amplifier, and
wherein the amplifier comprises an output pattern ID storing unit in which the output pattern IDs set in the audio sources are stored, and, when the audio data and the output pattern IDs are transmitted from the audio sources to the amplifier, one of the output pattern IDs transmitted from the audio sources is compared to one of the output pattern IDs stored in the output pattern ID storing unit and, if the compared output pattern IDs correspond, the amplifier outputs an audio signal according to an output specification of an audio source corresponding to the corresponding output pattern ID.
